(19) United States
(12) Patent Application Publication
(10) Pub. No.: US 2025/0183637 A1
(43) Pub. Date: Jun. 5, 2025

(54) WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Masahiro HAGI, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 18/839,800

(22) PCT Filed: Feb. 8, 2023
(86) PCT No.: PCT/JP2023/004218

§ 371 Date: Aug. 20, 2024

(30) Foreign Application Priority Data
Mar. 1, 2022 (JP) 2022-030830

(51) Int. Cl. H02G 3/04; H01B 7/00

(52) U.S. Cl. CPC H02G 3/0468; H01B 7/0045

(57) ABSTRACT

A wire harness that includes a first core wire; a second core wire; and an electrical connection that electrically connects the first core wire to the second core wire, wherein the electrical connection includes: a first connecting portion electrically connected to the first core wire; a second connecting portion electrically connected to the second core wire; and a bellows portion that has a bellows shape and is located between the first connecting portion and the second connecting portion.

### BACKGROUND

The present disclosure relates to a wire harness.

JP 2015-95280A discloses a coated wire. This coated wire has a removed portion from which an insulating coating has been removed. The removed portion has a flat portion formed by flatly pressing a conductive portion. A coating member for maintaining the shape of the flat portion covers the outer face of the flat portion. The coated wire, which includes the coating member maintaining the shape of the flat portion, is highly rigid and has poor bendability.

In contrast, a wire with a shield pipe of JP 2017-143614A can be easily bent. This wire with a shield pipe includes a wire and a shield pipe with the wire inserted. The shield pipe partially has a bellows shape and can be easily bent.

### SUMMARY

However, consideration is not given to the bendability of the wire inserted into the shield pipe in the technology of JP 2017-143614A either, and there is room for improvement in this respect.

An exemplary aspect of the disclosure provides a technology capable of making a wire to be easily bendable.

A wire harness of the present disclosure includes: a first core wire; a second core wire; and an electrical connection that electrically connects the first core wire to the second core wire, wherein the electrical connection includes: a first connecting portion electrically connected to the first core wire; a second connecting portion electrically connected to the second core wire; and a bellows portion that has a bellows shape and is located between the first connecting portion and the second connecting portion.

According to the present disclosure, a wire can be made easily bendable.

### BRIEF DESCRIPTION OF THE DRAWINGS

FIG. 1 is a configuration diagram that schematically shows a configuration of a wire harness of Embodiment 1.

FIG. 2 is a cross-sectional view of a connection component.

FIG. 3 is a plan view of a first wire and a second wire.

FIG. 4 is a cross-sectional view of the first wire and the second wire with the connection component attached.

FIG. 5 is a cross-sectional view of the first wire and the second wire with a waterproofing agent applied to a gap between the first wire and the connection component and a gap between the second wire and the connection component.

FIG. 6 is a cross-sectional view of a shrink tube covering an outer circumferential portion of the waterproofing agent.

FIG. 7 is a configuration diagram that schematically shows a configuration of a wire harness of Embodiment 2.

FIG. 8 shows a region of Embodiment 3 that corresponds to the region shown in FIG. 6.

### DETAILED DESCRIPTION OF EMBODIMENTS

### Description of Embodiments of Present Disclosure

Firstly, modes for carrying out the present disclosure are listed and described.

A wire harness of the present disclosure includes:
(1) a first wire having a first core wire; a second wire having a second core wire; and a connection component electrically connecting the first core wire to the second core wire, wherein the connection component has: a first connecting portion electrically connected to the first core wire; a second connecting portion electrically connected to the second core wire; and a bellows portion having a bellows shape and located between the first connecting portion and the second connecting portion.

With this configuration, the bellows portion being provided between the first and second core wires makes a region between the first and second core wires to be easily bendable. Thus, with this configuration, a wire constituted by the first and second wires and the connection component can be made easily bendable.
(2) The first connecting portion, the second connecting portion, and the bellows portion may each include: a tubular conductive portion electrically connected to both the first core wire and the second core wire; and an insulating portion located radially outward of the conductive portion.

With this configuration, the conductive portion can electrically connect the first core wire to the second core wire, and the insulating portion can electrically insulate the conductive portion from the outside.
(3) In the configuration of the above item (2), the first wire may have a first insulating coating covering an outer circumferential portion of the first core wire, the second wire may have a second insulating coating covering an outer circumferential portion of the second core wire, the first core wire may have a first exposed portion exposed from the first insulating coating at one end of the first wire, the second core wire may have a second exposed portion exposed from the second insulating coating at one end of the second wire, the first connecting portion may be electrically connected to the first exposed portion, and the second connecting portion may be electrically connected to the second exposed portion.

With this configuration, the first core wire can be electrically connected to the second core wire by the configuration in which the first connecting portion is electrically connected to the first exposed portion and the second connecting portion is electrically connected to the second exposed portion.
(4) In the configuration of the above item (3), the first connecting portion may be crimped to the first exposed portion, and the second connecting portion may be crimped to the second exposed portion.

With this configuration, the first and second connecting portions can be joined to the first and second exposed portions, respectively, by means of crimping.
(5) The wire harness may further include a waterproofing agent filling at least either a gap between the first wire and the connection component or a gap between the second wire and the connection component.

With this configuration, the waterproofing agent can prevent water from entering the gap.
(6) In the configuration of the above item (5), the wire harness may further include a shrink tube covering an outer circumferential portion of the waterproofing agent.

With this configuration, the contraction force of the shrink tube brings the waterproofing agent into intimate contact with the connection component and at least either the first wire or the second wire, thereby improving the effect of the waterproofing agent in preventing entry of water.
(7) The wire harness may further include an adhesive shrink tube configured by applying an adhesive to a shrink tube. The adhesive shrink tube may be adhered to the connection component and to at least either the first wire or the second wire, and may fill at least either a gap between the first wire and the connection component or a gap between the second wire and the connection component.

With this configuration, the adhesive shrink tube can prevent water from entering the gap.

### DETAILS OF EMBODIMENTS OF PRESENT DISCLOSURE

Specific examples of the present disclosure are described below with reference to the drawings. Note that the present disclosure is not limited to these examples but is defined by the claims, and is intended to include all changes made within the meaning and scope equivalent to the claims.

### Embodiment 1

### Configuration of Wire Harness

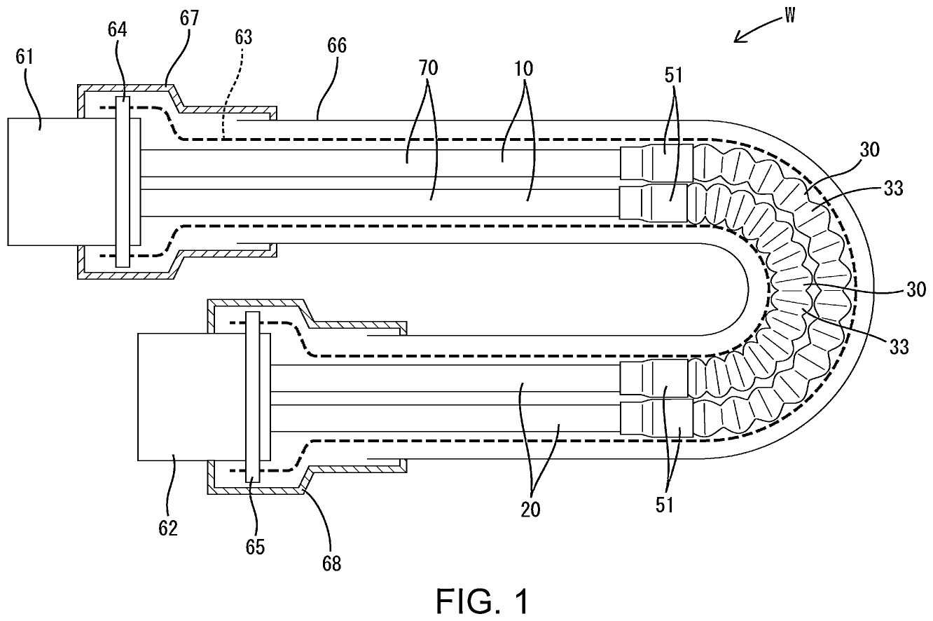

FIG. 1 discloses a wire harness W of Embodiment 1. As shown in FIG. 1, the wire harness W includes first wires 10, second wires 20, and connection components 30 (electrical connections).

Each first wire 10 is configured as a coated wire. As shown in FIG. 3, each first wire 10 includes a first core wire 11 and a first insulating coating 12. The first core wire 11 is conductive. The outer face of the first core wire 11, except for an end portion, is covered by the first insulating coating 12. The first core wire 11 has a first exposed portion 13 having an outer face exposed from one end of the first insulating coating 12. The first exposed portion 13 is provided at one end of the first core wire 11. The first insulating coating 12 has a tubular shape.

Each second wire 20 is configured as a coated wire. As shown in FIG. 3, each second wire 20 includes a second core wire 21 and a second insulating coating 22. The second core wire 21 is conductive. The outer face of the second core wire 21, except for an end portion, is covered by the second insulating coating 22. The second core wire 21 has a second exposed portion 23 having an outer face exposed from one end of the second insulating coating 22. The second exposed portion 23 is provided at one end of the second core wire 21. The second insulating coating 22 has a tubular shape.

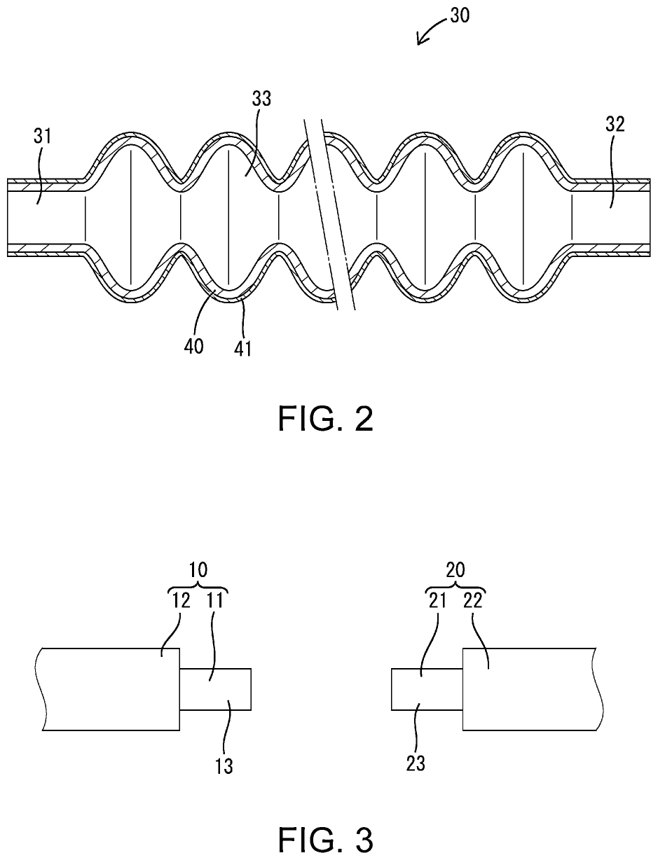

Each connection component 30 is a component that electrically connects a corresponding first core wire 11 to a corresponding second core wire 21. Each connection component 30 has a first connecting portion 31, a second connecting portion 32, and a bellows portion 33, as shown in FIG. 2.

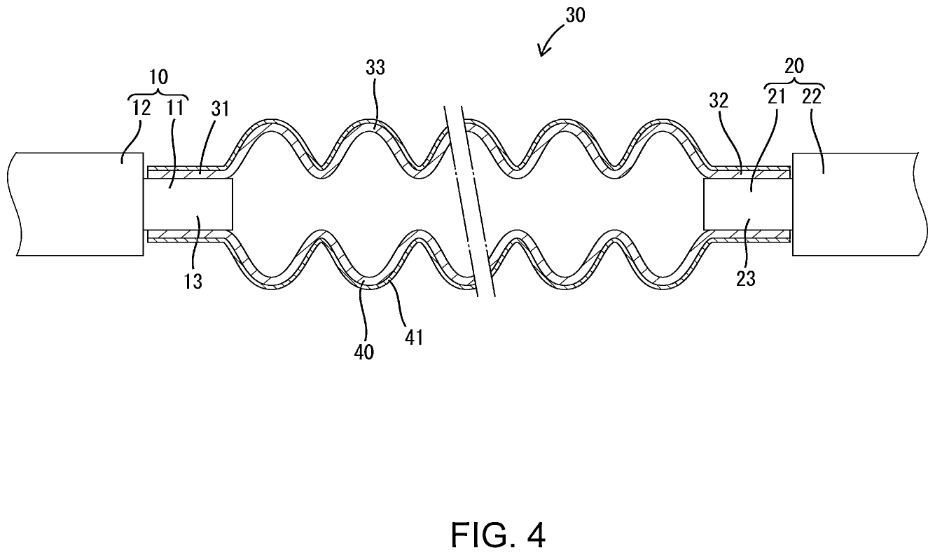

As shown in FIG. 4, the first connecting portion 31 is provided at one end of the connection component 30 and connected to the first wire 10. The first connecting portion 31 has a linearly extending tubular shape, and is crimped to the first exposed portion 13 that is inserted from an opening on one end side of the first connecting portion 31.

As shown in FIG. 4, the second connecting portion 32 is provided at the other end of the connection component 30 and connected to the second wire 20. The second connecting portion 32 has a linearly extending tubular shape, and is crimped to the second exposed portion 23 that is inserted from an opening on one end side of the second connecting portion 32.

The bellows portion 33 is provided between the first connecting portion 31 and the second connecting portion 32, as shown in FIG. 2. The bellows portion 33 has a bellows shape. The bellows shape refers to a shape in which the cross section cut along the axial direction has a wave shape or a shape with repeated projections and recesses. The bellows portion 33 is stretchable and bendable. The bellows portion 33 bends as a result of the wave shape or the shape with projections and recesses stretching on one side and contracting on the other side in a direction perpendicular to the axial direction.

As shown in FIG. 4, the first connecting portion 31, the second connecting portion 32, and the bellows portion 33 each include a conductive portion 40 and an insulating portion 41 (insulation). The conductive portion 40 is electrically connected to both the first core wire 11 and the second core wire 21. The conductive portion 40 has a tubular shape. The conductive portion 40 is made of metal, for example, and has a plate shape. The insulating portion 41 is located radially outward of the conductive portion 40. The insulating portion 41 has a tubular shape. The insulating portion 41 is adhered to the conductive portion 40. The insulating portion 41 has a coating thickness smaller than the plate thickness of the conductive portion 40.

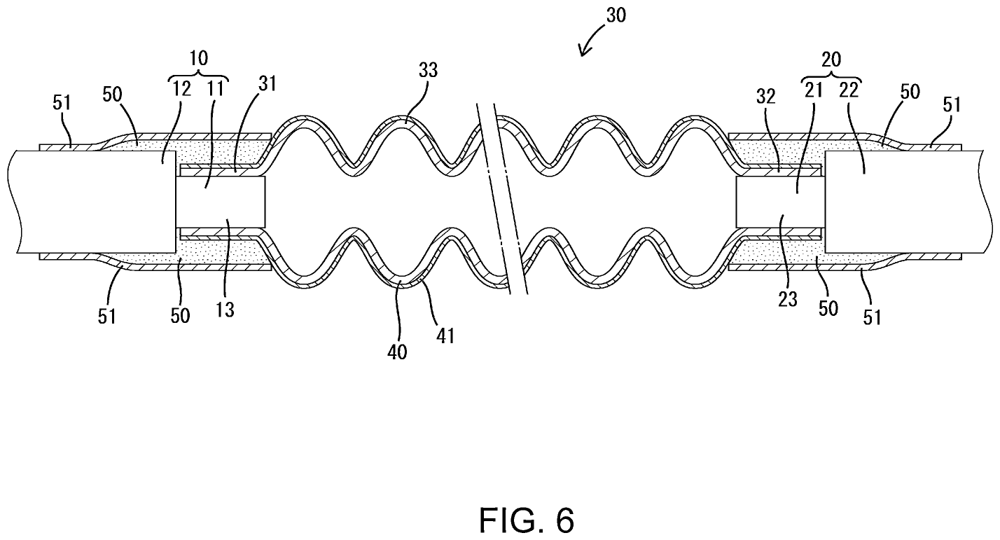

As shown in FIG. 6, the wire harness W includes a waterproofing agent 50 and shrink tubes 51. The waterproofing agent 50 is insulating. Examples of the waterproofing agent 50 include silicone resins, greases, butyl rubbers, epoxy resins, acrylic resins, thermoplastic resins, and other viscous and elastic adhesives. The present embodiment employs a silicone resin that hardens when dried. The waterproofing agent 50 is provided at two locations. The waterproofing agent 50 at one location fills a gap between the first wire 10 and the connection component 30 (more specifically, the first connecting portion 31). The waterproofing agent 50 at the other location fills a gap between the second wire 20 and the connection component 30 (more specifically, the second connecting portion 32).

The shrink tubes 51 are, for example, thermal shrink tubes. The shrink tubes 51 are made of a thermoplastic resin, for example. The shrink tubes 51 are insulating. Each shrink tube 51 has a tubular shape. Each shrink tube 51 is obtained by, for example, extruding a resin member into a very thin tubular shape, stretching this resin member into a thick tubular shape while heating the resin member, and then cooling the resulting member. The thus-obtained shrink tube 51 has shape memory properties, i.e., when heated, the shrink tube 51 shrinks back to the thin tubular shape that the shrink tube 51 had before being stretched. Two shrink tubes 51 are provided. The shrink tubes 51 surround outer circumferential portions of the waterproofing agent 50 at the respective locations.

As shown in FIG. 1, the wire harness W includes a first connector 61 and a second connector 62. The first connector 61 is insulating. The first connector 61 is made of a synthetic resin. The first connector 61 is connected to the other ends of the aforementioned first wires 10. The second connector 62 is insulating. The second connector 62 is made of a synthetic resin. The second connector 62 is connected to the other ends of the aforementioned second wires 20.

As shown in FIG. 1, the wire harness W includes a shielding member 63, a first joint member 64, and a second joint member 65. The shielding member 63 is conductive and has a tubular shape. The shielding member 63 is a braided wire. The shielding member 63 covers the plurality of first wires 10, the plurality of second wires 20, and the plurality of connection components 30. The shielding member 63 is joined, on one end side, to the outer face of the first connector 61 by the first joint member 64. The shielding member 63 is joined, on the other end side, to the outer face of the second connector 62 by the second joint member 65.

As shown in FIG. 1, the wire harness W includes an exterior member 66, a first protective member 67, and a second protective member 68. The exterior member 66 is insulating and has a tubular shape. The exterior member 66 is flexible and configured as, for example, a corrugated tube. The exterior member 66 covers an outer circumferential portion of the shielding member 63. The exterior member 66 is joined, on one end side, to the first connector 61 via the first protective member 67. The exterior member 66 is joined, on the other end side, to the second connector 62 via the second protective member 68. The first protective member 67 and the second protective member 68 are insulating and each have a tubular shape. The first protective member 67 is fixed to the outer face of the first connector 61 while covering the first joint member 64. The second protective member 68 is fixed to the outer face of the second connector 62 while covering the second joint member 65.

### Method of Producing Wire Harness

The connection component 30 of the wire harness W is produced as follows, for example. First, a cylindrical member made of a metal (e.g., aluminum) is produced. The cylindrical member is compressed from the radially outer side so as to form a bellows shape. The conductive portion 40 of the connection component 30 is thus formed. The outer face of the conductive portion 40 is coated with an insulating coating. Thus, an insulating layer constituted by the insulating portion 41 is formed on the outer face of the conductive portion 40. The connection component 30 is thus produced. Note that the method of producing the connection component 30 is not limited to this method. For example, the conductive portion 40 may alternatively be formed by casting.

Each of the first wire 10 and the second wire 20 are formed by removing the insulating coating at one end of a coated wire to expose the outer face of the core wire on one end side (see FIG. 3). As shown in FIG. 4, the first exposed portion 13 of the first core wire 11 is inserted into the first connecting portion 31 of the connection component 30 from one end side of the connection component 30. The first connecting portion 31 is crimped to the first exposed portion 13. The second exposed portion 23 of the second core wire 21 is inserted into the second connecting portion 32 of the connection component 30 from the other end side of the connection component 30. The second connecting portion 32 is crimped to the second exposed portion 23. Here, the first core wire 11 and the second core wire 21 are spaced apart from each other. A space is thus created inside the bellows portion 33. Thus, even if the bellows portion 33 bends, the inner face of the bellows portion 33 does not interfere with the first core wire 11 or the second core wire 21, and the bellows portion 33 can be easily bent.

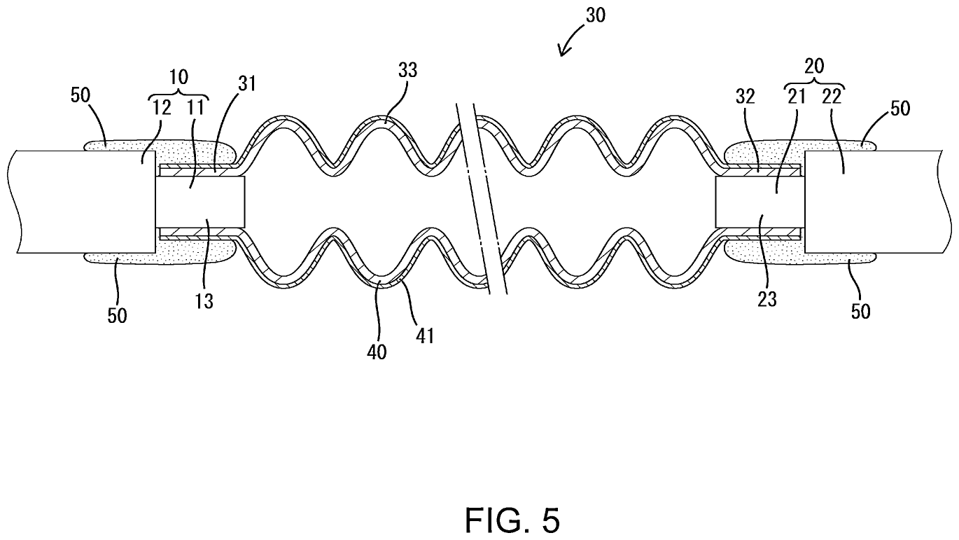

As shown in FIG. 5, the waterproofing agent 50 is applied so as to fill the gap between the first wire 10 and the connection component 30 and the gap between the second wire 20 and the connection component 30. As shown in FIG. 6, the shrink tubes 51 are attached and cover the outer circumferential portion of the waterproofing agent 50 at the respective locations. With the shrink tubes 51 attached, the waterproofing agent 50 adheres to the first wire 10, the second wire 20, and the connection component 30 to more reliably fill the gaps between those members.

The first wire 10, the second wire 20, and the connection component 30 are inserted into the tubular shielding member 63 from the other end side of the first wire 10 or the other end side of the second wire 20 such that the shielding member 63 covers the outer circumferential portions of the first wire 10, the second wire 20, and the connection component 30. Note that in FIG. 1, two bellows wires 70, each of which includes the first wire 10, the second wire 20, and the connection component 30, are inserted into the shielding member 63. The shielding member 63 is then inserted into the tubular exterior member 66 such that the exterior member 66 covers the outer circumferential portion of the shielding member 63.

The other end of each first wires 10 is connected to the first connector 61, and the other end of each second wire 20 is connected to the second connector 62. The shielding member 63 is joined, on one end side, to the outer face of the first connector 61 by the first joint member 64, and is joined, on the other end side, to the outer face of the second connector 62 by the second joint member 65. The exterior member 66 is fixed, on one end side, to the first connector 61 via the first protective member 67, and is fixed, on the other end side, to the second connector 62 via the second protective member 68. The wire harness W is thus produced. The wire harness W extends linearly when not elastically deformed. The wire harness W is in the state shown in FIG. 1 due to the region with the connection component 30 being bent. With the connection component 30 in a bent state, the elastic force of the wire harness W acts to return it to its original shape. The wire harness W is maintained in a bent state by being fixed to a body panel (not shown).

### Example Effect of Wire Harness

With the wire harness W, the region between the first core wire 11 and the second core wire 21 can be easily bent due to the bellows portion 33 being provided between the first core wire 11 and the second core wire 21. Thus, with the wire harness W, a wire constituted by the first wire 10, the second wire 20, and the connection component 30 can be made easily bendable.

Further, the first connecting portion 31, the second connecting portion 32, and the bellows portion 33 each include the tubular conductive portion 40 electrically connected to both the first core wire 11 and the second core wire 21, and the insulating portion 41 located radially outward of the conductive portion 40. With this configuration, the conductive portion 40 can electrically connect the first core wire 11 to the second core wire 21, and the insulating portion 41 can electrically insulate the conductive portion 40 from the outside.

Further, with the wire harness W, the first core wire 11 can be electrically connected to the second core wire 21 by the configuration in which the first connecting portion 31 is electrically connected to the first exposed portion 13, and the second connecting portion 32 is electrically connected to the second exposed portion 23.

Further, with the wire harness W, the first connecting portion 31 and the second connecting portion 32 can be joined to the first exposed portion 13 and the second exposed portion 23, respectively, by means of crimping.

Further, with the wire harness W, the waterproofing agent 50 can prevent water from entering the gap between the first wire 10 and the connection component 30, and the gap between the second wire 20 and the connection component 30.

Further, with the wire harness W, the contraction force of the shrink tube 51 brings the waterproofing agent 50 into intimate contact with the first wire 10, the second wire 20, and the connection component 30, thereby improving the effect of the waterproofing agent 50 in preventing entry of water.

### Embodiment 2

In Embodiment 1, an example has been described in which all of the wires inserted into the shielding member are bellows wires. However, some of the wires inserted into the shielding member need not be bellows wires. In Embodiment 2, an example is described in which a non-bellows wire without a bellows portion is inserted into the shielding member. Note that the same configurations as Embodiment 1 are assigned the same reference numerals, and detailed description thereof is omitted.

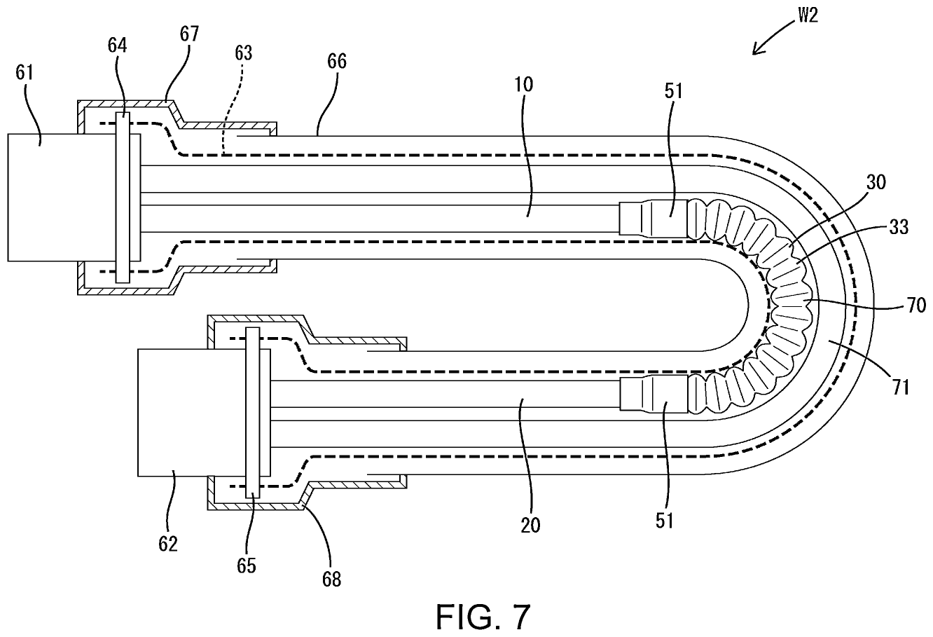

As shown in FIG. 7, a wire harness W2 of Embodiment 2 includes a bellows wire 70, a waterproofing agent 50, shrink tubes 51, a non-bellows wire 71, a first connector 61, a second connector 62, a shielding member 63, a first joint member 64, a second joint member 65, an exterior member 66, a first protective member 67, and a second protective member 68.

The non-bellows wire 71 is configured as a coated wire. One end of the non-bellows wire 71 is connected to the first connector 61, and the other end of the non-bellows wire 71 is connected to the second connector 62. As shown in FIG. 7, a connection component 30 of the bellows wire 70 is bent, and the non-bellows wire 71 is bent on the outer side of the bent connection component 30. If the bellows wire 70 is disposed on the outer side of the non-bellows wire 71, the curvature of the bellows wire 70 cannot be larger than or equal to the curvature of the non-bellows wire 71. This results in a smaller curvature of the entire wire harness W2. In contrast, when the bellows wire 70 is located on the inner side of the non-bellows wire 71, the curvature of the bellows wire 70 can be larger than or equal to the curvature of the non-bellows wire 71. This configuration thus makes it possible to increase the curvature of the entire wire harness W2.

### Embodiment 3

Embodiment 1 provides the configuration in which the wire harness includes the waterproofing agent and the shrink tubes. In contrast, in Embodiment 3, a configuration is described in which a wire harness includes adhesive shrink tubes instead of the waterproofing agent and the shrink tubes. Note that the same configurations as Embodiment 1 are assigned the same reference numerals, and detailed description thereof is omitted.

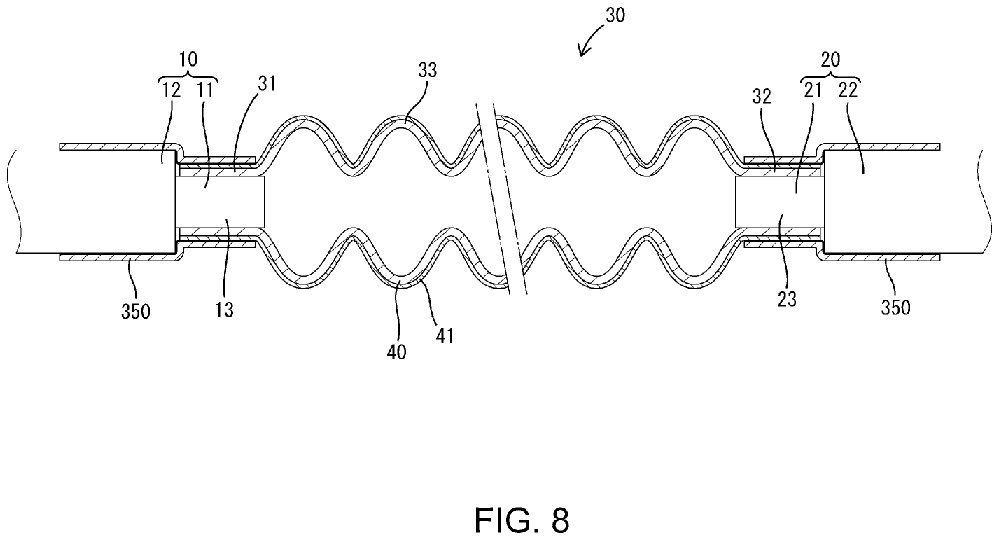

As shown in FIG. 8, a wire harness of Embodiment 3 includes a first wire 10, a second wire 20, a connection component 30, and adhesive shrink tubes 350.

The adhesive shrink tubes 350 are configured by applying the waterproofing agent 50 to the inner side of the shrink tubes 51 described in Embodiment 1. Two adhesive shrink tubes 350 are provided. One of the adhesive shrink tubes 350 is adhered to the first wire 10 and the connection component 30, and is disposed so as to fill the gap between the first wire 10 and the connection component 30. The other adhesive shrink tube 350 is adhered to the second wire 20 and the connection component 30, and is disposed so as to fill the gap between the second wire 20 and the connection component 30. With this configuration, the adhesive shrink tubes 350 can prevent water from entering the gap between the first wire 10 and the connection component 30 and the gap between the second wire 20 and the connection component 30.

### Other Embodiments of Present Disclosure

The embodiment disclosed herein is in all respects illustrative and should not be considered restrictive.
(1) In the above embodiments, the connection component is configured by applying an insulating coating to the outer face of the tubular conductive portion, but a different configuration may alternatively be employed. For example, the connection component may alternatively be configured by applying metal foil to the inner face of a resin-molded tubular insulating portion. Alternatively, the connection component may be configured by providing an insulating portion on the outer face of a tubular conductive portion by means of two-color molding.
(2) In the above embodiments, the first connecting portion has a tubular shape, but a different configuration may alternatively be employed. For example, the first connecting portion may alternatively have an open-barrel shape. The first connecting portion is crimped to the first core wire, but may alternatively be electrically connected to the first core wire by any other means. For example, the first connecting portion may be welded to the first core wire by a method such as ultrasonic bonding. The same as the first connecting portion applies to the 5 second connecting portion.
(3) The wire harness of Embodiment 1 prevents entry of water with the waterproofing agent and the shrink tube, but entry of water may alternatively be prevented by the waterproofing agent alone.

1. A wire harness comprising:
a first core wire;
a second core wire; and
an electrical connection that electrically connects the first core wire to the second core wire,
wherein the electrical connection includes:
a first connecting portion electrically connected to the first core wire;
a second connecting portion electrically connected to the second core wire; and
a bellows portion that has a bellows shape and is located between the first connecting portion and the second connecting portion.

2. The wire harness according to claim 1,
wherein the first connecting portion, the second connecting portion, and the bellows portion each include:
a tubular conductive portion electrically connected to both the first core wire and the second core wire; and
insulation located radially outward of the tubular conductive portion.

3. The wire harness according to claim 2, wherein:
a first insulating coating covers an outer circumferential portion of the first core wire,
a second insulating coating covers an outer circumferential portion of the second core wire,
the first core wire has a first exposed portion exposed from the first insulating coating at one end of the first core wire,
the second core wire has a second exposed portion exposed from the second insulating coating at one end of the second core wire,
the first connecting portion is electrically connected to the first exposed portion, and
the second connecting portion is electrically connected to the second exposed portion.

4. The wire harness according to claim 3, wherein:
the first connecting portion is crimped to the first exposed portion, and
the second connecting portion is crimped to the second exposed portion.

5. The wire harness according to claim 1, further comprising:
a waterproofing agent that fills at least either a gap between the first core wire and the electrical connection or a gap between the second core wire and the electrical connection.

6. The wire harness according to claim 5, further comprising:
a shrink tube that covers an outer circumferential portion of the waterproofing agent.

7. The wire harness according to claim 1, further comprising:
an adhesive shrink tube that is configured by applying an adhesive to a shrink tube,
wherein the adhesive shrink tube is adhered to the electrical connection and to at least either the first core wire or the second core wire, and fills at least either a gap between the first core wire and the electrical connection or a gap between the second core wire and the electrical connection.
